(19) United States
(12) Patent Application Publication
(10) Pub. No.: US 2007/0177399 A1
(43) Pub. Date: Aug. 2, 2007

(54) Lighting system for a vehicle and a method and a tool for producing the same

(75) Inventors: Jorg Lubs, Reutlingen (DE); Thegan Wolff, Kirchheim (DE)

Correspondence Address: CENTRAL COAST PATENT AGENCY, INC, 3 HANGAR WAY SUITE D, WATSONVILLE, CA, 95076, US

(73) Assignee: Automotive Lighting Reutlingen GmbH

(21) Appl. No.: 11/601,105

(22) Filed: Nov. 17, 2006

(30) Foreign Application Priority Data
Jan. 28, 2006 (DE) 10 2006 004 058.9

(51) Int. Cl. F21V 7/00

(52) U.S. Cl. 362/514

(57) ABSTRACT

For creating a lighting system (1) for a vehicle comprising a reflector (4) and a light source (5), wherein the lighting system (1) can be adapted with as low an outlay as possible to different specifications in regard to light distribution, it is proposed that a light distribution corresponding to a first specification can be created by the interaction between the reflector (4) and a first light source (5), and that a light distribution in accordance with a second specification can be created by the interaction between the reflector (4) and a second light source (5).

The invention relates to a lighting system for a vehicle, comprising a light source for emitting light beams and a reflector for reflecting the light beams emitted by the light source.

The invention also relates to a tool for producing a reflector, wherein the tool has a core and/or a die.

The invention moreover relates to a method for producing a lighting system for a vehicle by means of a tool having a core and/or a die, wherein the lighting system comprises a light source for emitting light beams and a reflector for reflecting the light beams emitted by the light source and the employment of the lighting system is intended to provide various specified light distributions.

The reflector faces of modern headlights and of many other systems are calculated these days by means of elaborate calculation methods and are produced by means of tools produced especially for this, for instance by an injection molding process. Customarily the reflector faces are designed in such a way that a distribution of the light generated at the reflector by means of the light beams emitted by a light source corresponds to a standard for light distribution. Such standards are set by national or regional regulations.

For example, in Germany a defined light distribution for headlights which are operated in connection with vehicles licensed in Germany is prescribed by the authorities charged with regulating traffic (Strassenverkehrszulassungsordnung [StVZO]). This regulation is a conversion of EC guidelines, which in turn correspond to EEC regulations. The corresponding regulations in the USA are compiled in FMVSS 108, for example, and are based in part on SAE standards.

A headlight which generates a light distribution in accordance with a defined standard can generally only be used in areas in which this regulation is applicable. The reason for this is, for example, that the reflector is highly optimized in accordance with the standards in order to achieve as high as possible a light output. This as a rule means that a light distribution optimized in this way cannot meet standards set for other regions.

However, this would be very desirable in principle, since the creation of a reflector is very elaborate and the outlay for this is always multiplied when the headlight is installed in a vehicle and this car model is to be licensed in different regions, since the creation of a respectively matched reflector is required for this.

It is therefore the object of the invention to make a system available which makes possible the matching of a headlight to different standards in respect to light distribution with as little outlay as possible.

This object is attained by a lighting system of the type mentioned at the outset in that a light distribution in accordance with a first specification is possible by the interaction between the reflector and a first light source, and that a light distribution in accordance with a second specification is possible by the interaction between the reflector and a second light source.

In this way the matching of the lighting system to different specification in regard to light distribution becomes possible by means of employing different light sources. Accordingly, in this case the reflector is designed in such a way that a reflection of light beams emitted by a first employed light source meets a defined specification in regard to light distribution. If a second light source is installed in this lighting system in place of the first light source, the light beams emitted by the second light source are reflected in such a way by the reflector that they meet a different specification in regard to light distribution. Therefore the adaptation of the headlights does not require a change of the reflector face, and in particular no production of a second reflector. The use of the very same reflector face, or of the very same reflector, which is employed in regions with different standards regarding light distribution and therefore would customarily have to be manufactured in different country variations, clearly reduces the outlay for the manufacture, or adaptation, of such a headlight.

The reflector preferably acts together with at least one lighting means in such a way that a light distribution optimized for at least one specification becomes possible. This makes it possible for the lighting system in accordance with the invention to generate an optimum light distribution at least for one country variation. Meeting of the specifications regarding light distribution of one or several further country variations is achieved by the employment of other light sources. However, the light distribution in regard to these further light variations need not be optimal.

For example, this is advantageous if a headlight is produced in especially large numbers for meeting a first specification regarding light distribution, and further country variations of this headlight need to be produced, or employed, only in relatively small numbers.

In accordance with an advantageous further development of the lighting system in accordance with the invention, the lighting system has an adapter element for the employment in at least one light source.

A holding device for the attachment or the installation of a light source is typically provided at a headlight. However, different light sources customarily have different so-called bases and therefore require different attachment fastening devices. However, by means of an adapter element fastening of a light source to a lighting system is possible, although the holding device of the lighting system is designed for fastening a different light source.

It is possible in particular to provide a universal holding device in the lighting system, so that any light source is fastened by means of an adapter on the lighting system. This allows a particularly fast adaptation of the lighting system in order to meet different specifications regarding light distribution.

In accordance with a particularly preferred embodiment of the lighting system of the invention, at least one element of the reflector which at least indirectly holds the light source is produced with the use of a tool having a core and a die. Depending on the light source to be used for meeting a specification, the core and/or the die can be adapted by the employment of a changeable insert.

Specializing the lighting system in respect to different country variations is realized by adapting the lighting system to the light source to be respectively used, wherein the adaptation is already performed in the course of producing the lighting system. However, in this case the reflector itself always remains unchanged in such a way that no elaborate re-manufacture, and in particular no renewed calculation of the reflector faces and production of the tool required for manufacturing the reflector, is needed.

Operation of the lighting system in accordance with the relevant EEC standards and in accordance with the relevant FMVSS standards is preferably achieved by means of the employment of different light sources. Depending on the light source used, this for example enables to operate the lighting system in Europe (light distribution in accordance with EEC standards) and in the USA (light distribution in accordance with FMVSS standards).

In accordance with a tool having a core and/or a die for producing a reflector in a light source, the object is achieved by providing a changeable insert for at least a portion of the core and/or the die in the tool, wherein at least that portion of the reflector is formed by means of the tool that is intended for at least indirectly holding the light source.

As a result, such a tool makes it possible that neither a new nor an adapted reflector nor a tool required for this need to be newly produced. Instead, a changeable insert is provided in the tool for producing the lighting system in accordance with the invention, which allows to produce a lighting system that matches different specifications by means of differently designed holding elements for holding the respectively intended light source.

The object is furthermore attained by a method for producing a lighting system of the type mentioned above in that, depending on the intended light distribution, a changeable insert is provided in at least a portion of the core and/or the die of the tool, wherein at least that portion of the reflector is formed by means of the changeable insert that is intended for at least indirectly holding a light source with which the defined light distribution is achieved.

Further characteristics, possible uses and advantages of the invention ensue from the following description of exemplary embodiments of the invention represented in the drawings. Shown are in:

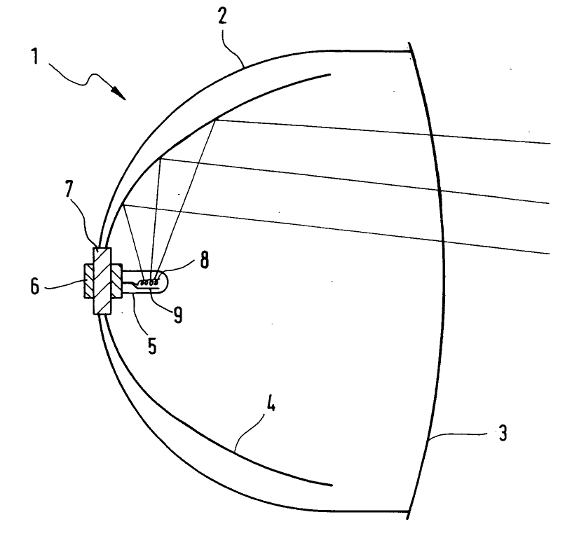

FIG. 1, a schematic representation of a lighting system.

A lighting system 1, for example a headlight for creating a low beam in a motor vehicle, is shown in FIG. 1 in a greatly schematized representation. The lighting system 1 has a housing 2, as well as a transparent pane 3. A reflector 4 is arranged in the housing 2. The reflector 4 is concavely curved and has an opening in its vertex area, through which a light source 5 can be introduced. The light source 5 has a base 6, which can be non-positively connected with a receiver 7.

The light source 5 has a coil 8 and a cap 9. However, the light source 5 can also be designed as a gas discharge lamp, for example a so-called Xenon lamp, in which case it does not have a coil 8. The light source 5 moreover has non-represented contact elements for making an electrical connection with a current source, also not represented.

In the switched-on state, the light source 4 emits light beams by means of the coil 8, through which current then flows or, in case a gas discharge lamp is used, by means of the created gas discharge, which are reflected at the reflector 4. In this case the reflector 4 has been worked in such a way that the reflected light beams meet defined specifications, in particular legal standards which apply in the country in which the vehicle equipped with the lighting system 1 is to be operated.

If, for example, a vehicle equipped with the lighting system 1 is registered in Europe or Japan, the lighting system must meet the so-called EEC standard. If, for example, a vehicle equipped with the lighting system 1 is to be registered in the USA, the lighting system 1, and in particular the light distribution generated by the lighting system 1, must meet a standard (FMVSS 108) which is applicable there.

If a vehicle model equipped with the lighting system 1 is to be sold in the USA, as well as in Europe, it is therefore customary to install different headlights, for example in the European models and in the US models. Customarily these different headlights have different reflectors 4.

However, by means of the lighting system 1 in accordance with the invention it is possible to easily match lighting systems 1 to different standards, for example legal regulations, in that the lighting system 1 is merely provided with a different light source 5.

This makes it possible, for example when producing the lighting system 1 for EU models and US models, to employ the same reflector 4. Then, depending on which light source 5 has been arranged in the lighting system 1, the light beams sent out by the lighting system 1 meet the respective regulations. In this case the receiver 7 can provide for the reception of an adapter, by means of which light sources 5 with different bases 6 can be fastened on the lighting system 1.

However, a decision is preferably already made when producing the lighting system 1 to which standards the light beams emitted by the lighting system 1 should adhere.

The reflector 4, as well as the housing 2, is made of metal by means of a casting process or of plastic by means of an injection molding process, for example. A tool with a core and a die, for example, is used for this. The receiver 7 is advantageously made as one piece with the housing 2 or the reflector 4, so that no subsequent assembly of these two parts needs to take place.

To realize a particularly simple production of a lighting system 1 adaptable to different standards, the tool has a changeable insert. Depending on the respective changeable insert to be used in connection with the tool, a lighting system 1 is produced having a receiver 7 intended for a defined light source 5. Accordingly, the production of headlights is possible which are designed with such differences, that the generated light distribution meets different standards, while nevertheless only one form of reflector needs to be produced for the different headlights so that the production of the differently adapted headlights is possible with the same tool, wherein merely a matched changeable insert must be inserted in the tool, if required. Since the manufacture of the reflector is very time- and cost intensive, this allows a particularly advantageous manufacture of lighting systems 1.

If an especially large number of lighting systems 1 are to meet a defined specification, and relatively few country variations for meeting different standards in respect to light distribution are to be met, it can be provided that the reflector 4, together with a defined light source 5, assures a particularly optimal distribution of the illumination for the first specification, however, while it is possible to meet other specifications by employing another light source 5, it is not necessary to achieve a very optimal distribution of the illumination in the latter case.

For example, the reflector 4 is produced in such a way that it is possible to provide an optimal light distribution with the lighting system 1 for a country variation, for example for the European market, in accordance with EEC standards. A variation of the lighting system 1, however, which is intended to comply with another country variation, i.e. for example the FMVSS standard valid in the USA, is then operated in connection with another light source 5. In this case the reflector 4 can be designed in such a way that a light distribution sufficient for meeting the legal standards in the USA can be achieved.

The lighting system 1 is of course not limited to the application for generating the low beam light, but can also be used in other headlights or lighting devices. For example, the lighting system 1 can have a high beam function, and the reflector 4 can be produced in such a way that it meets the EEC-R112 standard and achieves a high maximum illumination strength according to the light distribution.

As a more concrete application example it is possible to employ, for example, a so-called H9 lamp as the light source 5, so that an optimal light distribution, along with the simultaneous meeting of the relevant EEC standards, is achieved. A country variation of the lighting system 1 corresponding to FMVSS 108 then can have the same reflector 4. In this case, the reflector 4 has been worked in such a way that, for example, the use of a so-called HB-3 lamp as the light source 5 in this country variation results in a reduction of the maximum illumination strength, but the generated light distribution from this HB3 lamp meets the legal requirements in the USA.

1. A lighting system (1) for a vehicle, comprising a light source (5) for emitting light beams and a reflector (4) for reflecting the light beams emitted by the light source (5), characterized in that a light distribution in accordance with a first specification can be created by the interaction between the reflector (4) and a first light source (5), and that a light distribution in accordance with a second specification can be created by the interaction between the reflector (4) and a second light source (5).

2. The lighting system (1) in accordance with claim 1, characterized in that the lighting system (1) has an adapter element for the employment of at least one light source (5).

3. The lighting system (1) in accordance with claim 1, characterized in that the reflector (4) works together with at least one light source (5) in such a way that a light distribution, which is optimized according to at least one specification, becomes possible.

4. The lighting system (1) in accordance with claim 1, characterized in that at least one element of the reflector (4) which at least indirectly holds the light source (5) is produced with the use of a tool having a core and a die and, depending on the light source (5) to be used for meeting the specification, the core and/or the die can be adapted by the employment of a changeable insert.

5. The lighting system (1) in accordance with claim 1, characterized in that the employment of different light sources (5) enables an operation of the lighting system (1) in accordance with the relevant EEC standards and in accordance with the relevant FMVSS standards.

6. A tool for producing a reflector (4) in a lightsource (5), wherein the tool has a core and/or a die, characterized in that the tool provides a changeable insert for at least a portion of the core and/or the die, wherein at least that portion of the reflector (4) is formed by means of the tool which is intended to at least indirectly hold the light source.

7. A method for producing alighting system (1) for a vehicle by means of a tool having a core and/or a die wherein the lighting system (1) has a light source (5) for emitting light beams and a reflector (4) for the reflection of the light beams emitted by the light source (5), and a use of the lighting system (1) is intended in regard to different specified light distributions, characterized in that, depending on the specified light distribution, a changeable insert is inserted into at least a portion of the core and/or the die of the tool, wherein at least that portion of the reflector (4) is formed by means of the changeable insert which is intended to at least indirectly hold a light source (5) with which the specified light distribution is achieved.

8. The method of claim 7, characterized in that the specifications regarding the light distribution are defined by an EEC standard or an FMVSS standard.
